(19) United States
(12) Patent Application Publication
(10) Pub. No.: US 2013/0235991 A1
(43) Pub. Date: Sep. 12, 2013

(54) TELECOMMUNICATION PRIVATE WIRE NETWORK

(71) Applicant: AVT TECHNOLOGY LTD., London (GB)

(72) Inventor: Mike Fenton, Herts (GB)

(73) Assignee: AVT Technology Ltd., London (GB)

(21) Appl. No.: 13/788,221

(22) Filed: Mar. 7, 2013

(30) Foreign Application Priority Data
Mar. 9, 2012 (GB) 1204242.0

(51) Int. Cl. H04M 3/527

(52) U.S. Cl. CPC H04M 3/527
USPC 379/167.14

(57) ABSTRACT

According to the present invention, there is provided a telecommunication Private Wire network comprising: a centralised switch and a number of locations with corresponding end points each of which is connected to said centralised switch by one or more dynamic Private Wires, said centralised switch including means for identifying each location and the end points within that location, a directory for storing details of each location and the corresponding end points, a directory search mechanism and a control means coupled to said identifying means, said directory and said directory search mechanism for receiving an invite from a requesting end point at one of the locations, using the directory search mechanism to identify the receiving end point at a location and the requesting end point at a location in said invite and for establishing a virtual Private Wire between said receiving end point at a location and said requesting end point at a location.

### BACKGROUND OF INVENTION

1. Field of Invention

The present invention relates to telecommunications systems and in particular to a telecommunication private wire network.

2. Description of the Related Art

A private wire is a point-to-point voice connection that provides guaranteed voice connectivity between two locations. For example, location A and location B have a private wire connection between them; this connection will ensure that voice communications can be delivered between the two locations at any time. A private wire is also known as a voice private line.

Private wires are delivered by providing dedicated bandwidth between two points that is suitable to transmit audio or voice.

Private wire connections are often used in the financial markets, utilities, emergency services and railways as their mission-critical voice delivery guarantees meet the demands of these industries.

To receive or deliver voice via the private wire, specialised telecommunications equipment is usually required. For example, in the financial markets organisations use trading turret devices, these are similar to desktop phones but have multiple handsets and speakers enabling a user to access multiple concurrent audio streams or voice conversations.

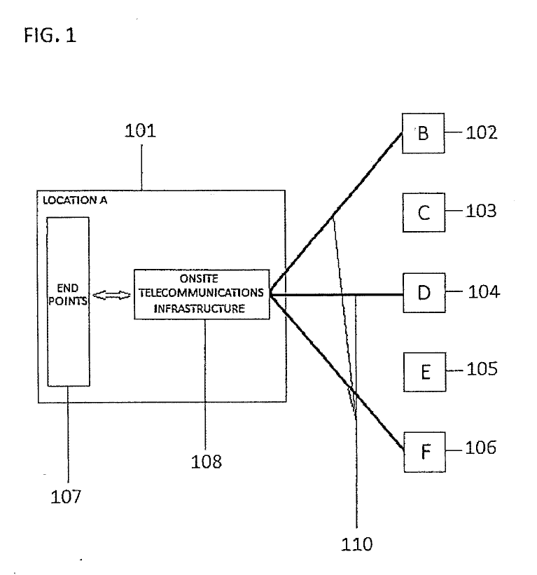

FIG. 1 illustrates a traditional Time Division Multiplexing (“TDM”) private wire deployment. Location A 101 has voice private wires 110 to locations B 102, D 104 and F 106. The diagram has been simplified in scale; in reality a location can have large numbers of private wires to other locations.

The end points 107 can access the private wires via location A's 101 specialised telecommunications infrastructure 108. FIG. 1 also shows that location A 101 does not have private wire connections to locations C 103 and E 105, because private wires 110 are complex, difficult and slow to install and those disadvantages of location A 101 connecting to locations C 103 and E 105 outweighs the benefit.

A few of the shortcomings of the traditional TDM deployment include long provisioning times, for example, it can take up to three months for a new connection to be delivered. The private wire connections are static and therefore can only ever be used to connect from one point to another. Disaster recovery solutions become complex and expensive, when for example an organisation's main site (location) becomes inaccessible a suitable plan and infrastructure is required for the employees to carry out their duties. With the advent of Internet Protocol (“IP”), private wires can now be delivered via an IP network. As the telecommunications equipment that accept private wires at a location might still only accept a TDM connection; the incoming IP connection can be converted to a suitable TDM connection, this would form part of the location's onsite telecommunications infrastructure. Other packet switched technologies could be used in conjunction with IP, or even replace IP completely, to provide the private wire. Delivery of a private wire via IP can improve the provisioning times significantly and enable more simplified and cost effective disaster recovery solutions to be deployed. IP private wire networks can also include a self-provisioning portal that enables the management of private wire connections at a location. For example, via the self-provisioning portal a new private wire can be established between locations on the same private wire network. However, as a private wire requires a certain amount of bandwidth, and must always be accessible/usable, the number of private wires that can be self-provisioned at that location is limited by the total bandwidth permitted by the service provider.

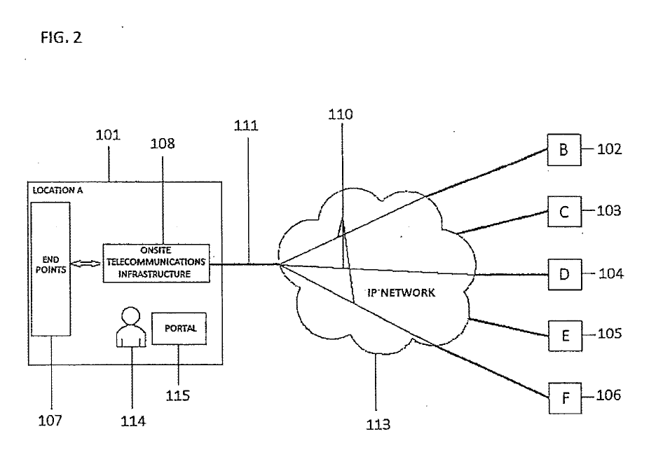

FIG. 2 shows a simplified private wire deployment via an IP network. Location A 101 has a dedicated network connection 111 to an IP private wire network provider. Via a portal 115, an onsite administrator 114 can establish and end private wire connections 110 to other locations B 102, C 103, D 104, E 105 and F 106 connected to the same IP private wire network provider.

The private wire connections 110 illustrated in FIG. 2 are dedicated streams of bandwidth that provide a virtual point-to-point connection that can deliver guaranteed voice communications. The private wire connections 110 consume the same amount of bandwidth whether voice or audio is transmitted or not. Therefore FIG. 2 also illustrates that the cost of location A 101 establishing private wires with locations C 103 and E 105 still outweigh the benefits.

The short coming that both TDM and IP private wires fail to address is that each private wire requires a certain amount of bandwidth regardless of whether audio is or is not transmitted as the connection service between locations must always be accessible/usable at all times.

For example, an end point at a location has specialised telecommunications infrastructure that enables access to two concurrent audio streams or voice conversations, i.e. handset one and two, and has ten private wires. This end point is charged for ten concurrent private wires when only two can be accessed at the same time.

In addition to this the telecommunications infrastructure at a location often enables private wires to be shared amongst multiple end points. This can create bottlenecks, for example, end point 1 at location A is accessing a private wire connection via the onsite telecommunications infrastructure to an end point at location B. If end point 2 at location A wants to access the same private wire to speak to an end point at location B, it must wait until the tine is free. Or, if the onsite telecommunications infrastructure provides the functionality and end point 1 permits it, end point 2 must conference into the in-use private wire.

Accordingly, there is a need for a private wire to deliver guaranteed connectivity to an end point so that real time communication can take place with any other end point connected to the same private wire service.

In U.S. Pat. No. 4,982,421 by Kirsch dated January 1991 it states that “In accordance with one feature of the invention, each end of the private line can access or be accessed by only the other end of the private line.”

The system in this prior art uses the identity of the calling station to identify the identity of the target, i.e. there is a pre-set direct mapping held by the system linking the two ends making them a fixed pair. This means that each calling station can only call or be called by its paired calling station. This is an intended feature of the prior art as it prevents unwanted communication from other calling stations and it helps improve the time taken to establish the connection.

In other prior art, the terms virtual or dynamic private wires are often used but all still suffer from the disadvantages set out above and none achieve the significant advantages gained by the present invention.

### BRIEF DESCRIPTION

An aim of the present invention is a telecommunication private wire network which does not suffer from these disadvantages. In particular, in the prior art noted above, the system restricts the stations which can be called. The present invention has no such restriction. Each dynamic private wire can be used in calls with multiple other dynamic private wires. This is a primary advantage of the invention.

Accordingly, end points can manage their private wire connection in real time so that they can choose who they communicate with and when via a guaranteed voice connection.

The present invention also increases the deployment options available at locations or for end points. Currently specialised telecommunications infrastructure is required to suitably access a private wire, the invention removes this requirement.

According to the present invention, there is provided a telecommunication Private Wire network comprising: a centralised switch and a number of locations with corresponding end points each of which is connected to said centralised switch by one or more dynamic Private Wires, said centralised switch including means for identifying each location and the end points within that location, a directory for storing details of each location and the corresponding end points, a directory search mechanism and a control means coupled to said identifying means, said directory and said directory search mechanism for receiving an invite from a requesting end point at one of the locations, using the directory search mechanism to identify the receiving end point at a location and the requesting end point at a location in said invite and for establishing a virtual Private Wire between said receiving end point at a location and said requesting end point at a location.

Preferably, said control means includes a counter for counting the number and bandwidth of dynamic Private Wires in use between locations, their corresponding end points and the centralised switch.

In addition, each dynamic Private Wire has a predetermined bandwidth and this is stored in said directory together with details of the respective end points and their location.

Moreover, said control means limits the dynamic Private Wires if the number and bandwidth stored in the counter exceeds the details stored in the directory.

The present invention may further comprise two or more centralised switches, each centralised switch connected to each other by a network with sufficient bandwidth to support a number of dynamic private wires.

Most preferably, each said directory also stores details of the respective centralised switch to which the location and it's corresponding end points are connected and each said control means uses the respective directory search mechanism to establish the centralised switch connected to the requested location and their end points for enabling the virtual Private Wire to be established through the dynamic Private Wire between the receiving and requested centralised switches.

An example of the present invention will now be described with reference to the accompanying drawings of which:

FIG. 1 is a schematic diagram of a prior art TDM private wire system;

FIG. 2 is a schematic diagram of a prior art IP private wire system; and

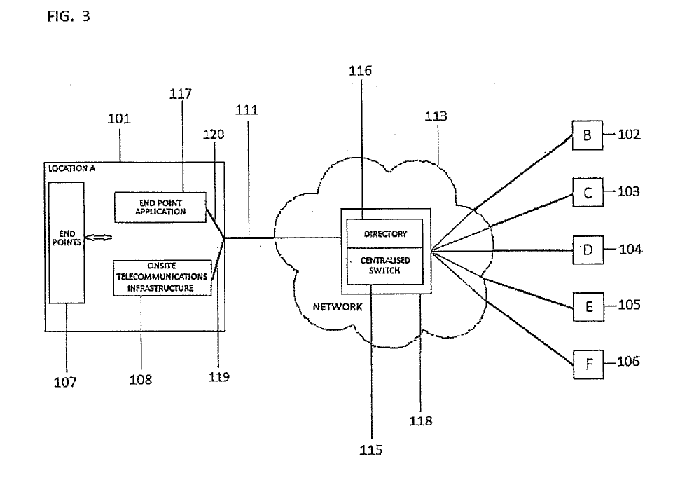

FIG. 3 is a schematic diagram of the present invention.

### DETAILED DESCRIPTION

In FIG. 3, 101 is an example of a location that has end points 107 that require private wire access to end points at other locations B 102 to F 106. In this diagram we can assume that locations B 102 to F 106 have a very similar composition to location A 101, that is they consist of end points 107, the end point's control application 117 and the location's onsite telecommunications infrastructure 108.

According to the present invention, end points 107 will have real time private wire voice access to any other end point connected to the system. This is achieved through a combination of guaranteed bandwidth connectivity 111 between location A 101 and the system's network 113, centralised switch 115, a directory 116, and an end point application 117 that controls the private wire.

The network 113 includes an intelligent routing system 118. This system includes a mechanism that ensures there is sufficient bandwidth available for a specified number of concurrent voice and/or data channels between the locations A 101 to F 106 and the centralised switch 115. This predetermined number of concurrent channels is specified by each end point. If there is insufficient bandwidth available the system will only add to the end points authorized call list, those calls that can be accommodated. The system 118 can enable an end point 107 to direct the call to any other end point connected to the network 113.

The system 118 comprises a centralised switch 115 and a directory 116. The end points 107 are each connected to an application 117 that provides real time control of the private wire, enabling them to select which end points at locations B 102 to F 106, that are also connected to the network 113, they want to communicate with. The end points 107 can choose to have their dynamic private wire operating as an open, always on, connection to the centralised switch 115 or as a connection that becomes active once they have selected which end points at locations B 102 to F 106 they want to communicate with via the dynamic private wire. The centralised switch 115 can consist of multiple data centres, in which case the bandwidth between each data centre must be sufficient for the worst case scenario, i.e. every end point activates or uses all its available channels concurrently. Any inter data centre bandwidth shortages will be treated in the same manner as a shortage between locations A 101 to F 106 and the centralised switch 115.

The data sent across connection 111 can be separated at location A 101 so that the audio stream 119 can be sent to the onsite telecommunications infrastructure 108 and the control 120 of the private wire can be sent to the end point application 117. The onsite telecommunications infrastructure 108 can consist of specialised telecommunications equipment (for example a trading turret system), a PBX system or mobile devices. The end point application 117 can be accessed from any IP enabled device that is capable of establishing an IP connection to system 118 or of accepting one from system 118, including a desktop computer.

The directory 116 stores information regarding the end points 107 within a location A 101. This information relates to the identification of the end point, it's location and where the audio and/or data stream is to be delivered. The directory 116 will also store information regarding end points 107 contact lists and provide tools to enable them to search the directory 116 to establish new contacts. New contacts are established once the end point that receives a request to become a contact with the sender approves. The approval can be can be one-way or two-way communication, in one-way communication only one end point has permission to initiate the call whereas in two-way communication either end point can initiate the call. The directory 116 and end point application 117 will provide tools that enable end points 107 to create groups, consisting of other end points connected to the network 113, so that contacts can be shared between them. This provides the ability for all end points of a group to see an incoming private wire connection and the status of all other shared contacts.

The end point application 117 can also be used to both control the private wire and communicate via the private wire; this enables end points 107 to use the private wires without the onsite telecommunications infrastructure 108.

The present invention has been described with reference to various examples and it is to be understood by those skilled in the art that modifications may be included in the scope of the present invention as defined in the claims.

1. A telecommunication Private Wire network comprising: a centralised switch and a number of locations with corresponding end points each of which is connected to said centralised switch by one or more dynamic Private Wires, said centralised switch including means for identifying each location and the end points within that location, a directory for storing details of each location and the corresponding end points, a directory search mechanism and a control means coupled to said identifying means, said directory and said directory search mechanism for receiving an invite from a requesting end point at one of the locations, using the directory search mechanism to identify the receiving end point at a location and the requesting end point at a location in said invite and for establishing a virtual Private Wire between said receiving end point at a location and said requesting end point at a location.

2. A telecommunication Private Wire network as claimed in claim 1, in which said control means includes a counter for counting the number and bandwidth of dynamic Private Wires in use between locations, their corresponding end points and the centralised switch.

3. A telecommunication Private Wire network as claimed in claim 2, in which each dynamic Private Wire has a predetermined bandwidth and this is stored in said directory together with details of the respective end points and their location.

4. A telecommunication Private Wire network as claimed in claim 3, in which said control means limits the dynamic Private Wires if the number and bandwidth stored in the counter exceeds the details stored in the directory.

5. A telecommunication Private Wire network, as claimed in claim 1, further comprising two or more centralised switches, each centralised switch connected to each other by a network with sufficient bandwidth to support a number of dynamic private wires.

6. A telecommunication Private Wire network, as claimed in claim 5, in which each said directory also stores details of the respective centralised switch to which the location and it's corresponding end points are connected and each said control means uses the respective directory search mechanism to establish the centralised switch connected to the requested location and it's end points for enabling the virtual Private Wire to be established through the dynamic Private Wire between the receiving and requested centralised switches.

7. A telecommunications Private Wire network, as claimed in claim 6, in which only connections between end points who have given their approval for communication with the other party are allowed.

8. A telecommunication Private Wire network, as claimed in claim 7, in which an end point has a dynamic private wire connected with the centralised switch and has the ability to direct the other half of the virtual private wire to any of their approved end points.

9. A telecommunications Private Wire network, as claimed in claim 8, in which a group of end points can share a dynamic private wire and receive information regarding the status of the dynamic private wire in real time.

10. A telecommunication Private Wire network as claimed in s 1, in which said telecommunication comprises voice data and/or instant message and/or video.
